(19) United States
(12) Patent Application Publication
(10) Pub. No.: US 2002/0138715 A1
(43) Pub. Date: Sep. 26, 2002

(54) Microprocessor executing data transfer between memory and register and data transfer between registers in response to single push/pop instruction

(75) Inventor: Isao Minematsu, Hyogo (JP)

Correspondence Address: McDERMOTT, WILL & EMERY, 600 13th Street, N. W., Washington, DC, 20005-3096, US

(73) Assignee: Mitsubishi Denki Kabushiki Kaisha

(21) Appl. No.: 09/819,990

(22) Filed: Mar. 29, 2001

(30) Foreign Application Priority Data
Jun. 28, 2000 (JP) 2000-194033(P)

(51) Int. Cl. G06F 9/00

(52) U.S. Cl. 712/225

(57) ABSTRACT

A microprocessor includes a program control unit controlling fetch of an instruction code, an instruction decode unit decoding the fetched instruction code, an address operation unit operating an address of a memory on the basis of the result of decoding by the instruction decode unit and a data operation unit executing data transfer between a control register and a work register and data transfer between the work register and an X memory in correspondence to a single push instruction. Therefore, data stored in the control register incapable of directly pushing data on the memory can be pushed with a single push instruction.

### BACKGROUND OF THE INVENTION

1. Field of the Invention

The present invention relates to a microprocessor and an assembler converting a program to a machine language executable by the microprocessor, and more particularly, it relates to a microprocessor and an assembler efficiently pushing/popping data on/from a stack and a recording medium recording a program thereof.

2. Description of the Prior Art

Microprocessors are recently used for various types of electronic apparatuses including an information processor such as a personal computer. When executing a program, a microprocessor generally assigns part of a memory to a stack area in order to temporarily push current values stored in a register. The microprocessor pushes/pops data on/from the stack by the LIFO (last-in first-out) method.

Such a microprocessor uses a stack pointer as a register for managing the position of data lastly pushed on the stack. The stack pointer may be implemented in the microprocessor as a dedicated register, or one of general-purpose registers may be used as a stack pointer. In order to make a microprocessor having an instruction length of at least 16 bits perform an operation of pushing the contents of a register on a stack or popping data stored in the stack to the register, the target register and the operation are generally specified through software.

Registers included in a recently mainstreamed microprocessor of the RISC (reduced instruction set computer) system are roughly classified into a register (hereinafter referred to as a data register) capable of directly reading/writing data from/in a memory and a register (hereinafter generically referred to as a control register) incapable of directly reading/writing data from/in the memory.

In order to push the contents of the control register on a stack or pop data stored in the stack to the control register, the data must be temporarily transferred from the control register to a work register to be thereafter written in the stack or the data stored in the stack must be temporarily read onto the work register to be thereafter transferred to the control register. In this case, therefore, an additional number of program steps are disadvantageously required as compared with the case of pushing the contents of the data register on the stack or popping data stored in the stack to the data register.

In a microprocessor having all registers capable of directly reading/writing data from/in a memory, the number of program steps for pushing the contents of any register on a stack or popping data stored in the stack to the register is smaller than that in the aforementioned microprocessor of the RISC system. In this case, however, the structure of a circuit for selecting the register is so complicated that it is difficult to increase an operating frequency as compared with the microprocessor of the RISC system.

### SUMMARY OF THE INVENTION

An object of the present invention is to provide a microprocessor capable of pushing/popping data stored in a plurality of control registers with a program having a small number of steps while employing a circuit structure applied to a microprocessor of the RISC system.

Another object of the present invention is to provide an assembler capable of performing a complicated stack operation with a simple macro instruction, a method thereof and a recording medium recording a program therefor.

Still another object of the present invention is to provide an assembler capable of automatically managing consistency of push/pop of a plurality of control registers, a method thereof and a recording medium recording a program therefor.

According to an aspect of the present invention, a microprocessor includes a program control unit controlling fetch of an instruction code, an instruction decode unit decoding the fetched instruction code, an address operation unit operating an address of a memory on the basis of the result of decoding by the instruction decode unit and a data operation unit operating data on the basis of the result of decoding by the instruction decode unit, and the data operation unit executes data transfer between registers and data transfer between the registers and the memory in correspondence to a single instruction code having a single operation code fetched by the program control unit.

The microprocessor can execute data transfer between the registers and data transfer between the registers and the memory with a single instruction code, whereby the number of steps of a program for prescribed processing can be reduced.

According to another aspect of the present invention, an assembler includes a code reading unit reading a code from a source program, a storage unit storing information for specifying a plurality of registers, a first code generation unit storing the information for specifying the plurality of registers included in the code read by the code reading unit in the storage unit and generating a code to push data stored in the plurality of registers when the code is a first macro instruction, and a second code generation unit referring to the information for specifying the plurality of registers stored in the storage unit and generating a code to pop data stored in the plurality of registers when the code read by the code reading unit is a second macro instruction.

The first code generation unit generates the code to push data stored in the plurality of registers from the first macro instruction, whereby a complicated stack operation can be handled with a single macro instruction. The second code generation unit refers to the information for specifying the plurality of registers stored in the storage unit and generates the code to pop data stored in the plurality of registers, whereby a complicated stack operation can be handled with a single macro instruction for automatically managing consistency of push/pop of the plurality of registers.

According to still another aspect of the present invention, a storage medium readable by a computer records an assembly program for making the computer execute an assembly method, which includes steps of reading a code from a source program, storing information for specifying a plurality of registers included in the code and generating a code to push data stored in the plurality of registers when the code is a first macro instruction, and referring to the stored information for specifying the plurality of registers and generating a code to pop data stored in the plurality of registers when the read code is a second macro instruction.

The code to push the plurality of registers is generated from the first macro instruction, whereby a complicated stack operation can be handled with a single macro instruction. When the read code is a second macro instruction, the code to pop data stored in the plurality of registers is generated with reference to the stored information for specifying the plurality of registers, whereby a complicated stack operation can be handled with a single macro instruction for automatically managing consistency of push/pop of the plurality of registers.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are diagrams for illustrating a register set forming a microprocessor according to a first embodiment of the present invention;

FIG. 2 is a block diagram schematically showing the structure of the microprocessor according to the first embodiment of the present invention;

FIG. 3 is a diagram for illustrating pipeline processing of the microprocessor according to the first embodiment of the present invention;

FIG. 4 illustrates exemplary operation instructions processed by the microprocessor according to the first embodiment of the present invention;

FIG. 5 illustrates exemplary transfer instructions, sequence control instructions and special instructions processed by the microprocessor according to the first embodiment of the present invention;

FIG. 6 shows a list of registers that can be specified in a LOAD instruction and a STORE instruction;

FIG. 7 illustrates an exemplary program for pushing data stored in registers with the STORE instruction;

FIGS. 8A to 8D illustrate operations of a stack upon execution of the program shown in FIG. 7; FIGS. 9A to 9C are diagrams for illustrating mnemonics of a POP instruction, a PUSH instruction and a PUT instruction and operations thereof;

FIG. 10 illustrates an exemplary program using the POP instruction, the PUSH instruction and the PUT instruction;

FIGS. 11A to 11H are diagrams for illustrating operations of the stack upon execution of the program shown in FIG. 10;

FIG. 12 is a block diagram showing an exemplary structure of a computer implementing an assembler according to a second embodiment of the present invention;

FIGS. 13A to 13C are diagrams for illustrating macro instructions processed by the assembler according to the second embodiment of the present invention;

FIG. 14 is a block diagram schematically showing the structure of the assembler according to the second embodiment of the present invention;

FIG. 15 is a flow chart for illustrating the procedure of the assembler according to the second embodiment of the present invention;

FIG. 16 is a flow chart for illustrating the processing at a step S3 shown in FIG. 15 in further detail;

FIG. 17 is a flow chart for illustrating the processing at a step S5 shown in FIG. 15 in further detail;

FIGS. 18A to 18C are diagrams for illustrating macro instructions processed by an assembler according to a third embodiment of the present invention; and

FIG. 19 is a flow chart for illustrating the processing at the step S3 shown in FIG. 15 in further detail.

### DESCRIPTION OF THE PREFERRED EMBODIMENTS

### First Embodiment

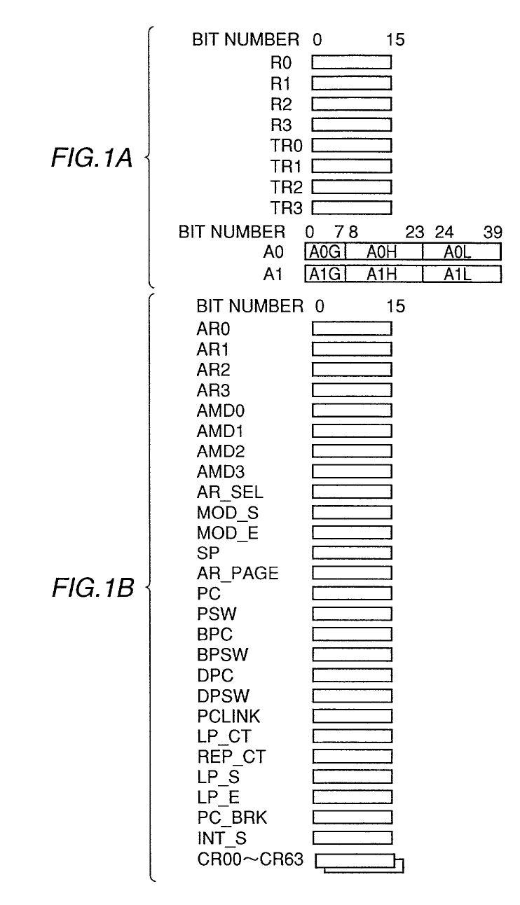

FIGS. 1A and 1B are diagrams for illustrating a register set included in a microprocessor according to a first embodiment of the present invention. While the microprocessor according to this embodiment has a data length of 16 bits, the present invention is not restricted to this.

Four operation source registers shown in FIG. 1A R0 to R3 store operation sources. Four work registers TR0 to TR3 temporarily hold addresses or data (operation sources or results). 40-bit accumulators A0 and A1 include bits A0H and A1H holding 16 upper bits of the operation sources or the results, bits A0L and A1L holding 16 lower bits of the operation sources or the results and guard bits A0G and A1G having an eight-bit length holding bits overflowed from the upper bits.

Referring to FIG. 1B, four address registers AR0 to AR3 store addresses in memory access. Four addressing mode registers AMD0 to AMD3 store addressing modes for memory access with AR0 to AR3 respectively. An AR assignment register AR_SEL is used for selecting the address registers AR0 to AR3.

Control registers MOD_S and MOD_E for modulo addressing hold a modulo start address and a modulo end address respectively. A stack pointer SP holds a head address of a stack. A page addressing register AR_PAGE stores a page head address in the case of addressing a memory in units of pages.

A program counter PC holds the address of a program currently executed by the microprocessor. A processor status word PSW stores flags, etc. for controlling the microprocessor. A backup program counter BPC and a backup processor status word BPSW automatically copy the values of the program counter PC and the processor status word PSW respectively upon occurrence of an event such as an interruption.

A debugger program counter DPC and a debugger processor status word DPSW automatically copy the values of the program counter PC and the processor status word PSW respectively upon occurrence of a debugging interruption event. A link register PCLINK holds a return address from a subroutine. A loop counter LP_CT and a repeat counter REP_C hold a block repeat count and a single instruction repeat count respectively.

Registers LP_S and LP_E specify a head address and an end address of the block repeat respectively. A register PC_BRK is utilized when specifying a hardware breakpoint. A register INT_S is an interruption status register. I/O mapped registers CR00 to CR63 are utilized for inputting/outputting data from/ to a peripheral I/O (input/output) device. The register INT_S and the I/O mapped registers CR00 to CR63, used for controlling the input/output device connected with an external device and not directly related to this embodiment, are not described in detail. In the following description, it is assumed that a single instruction code includes a single operation code.

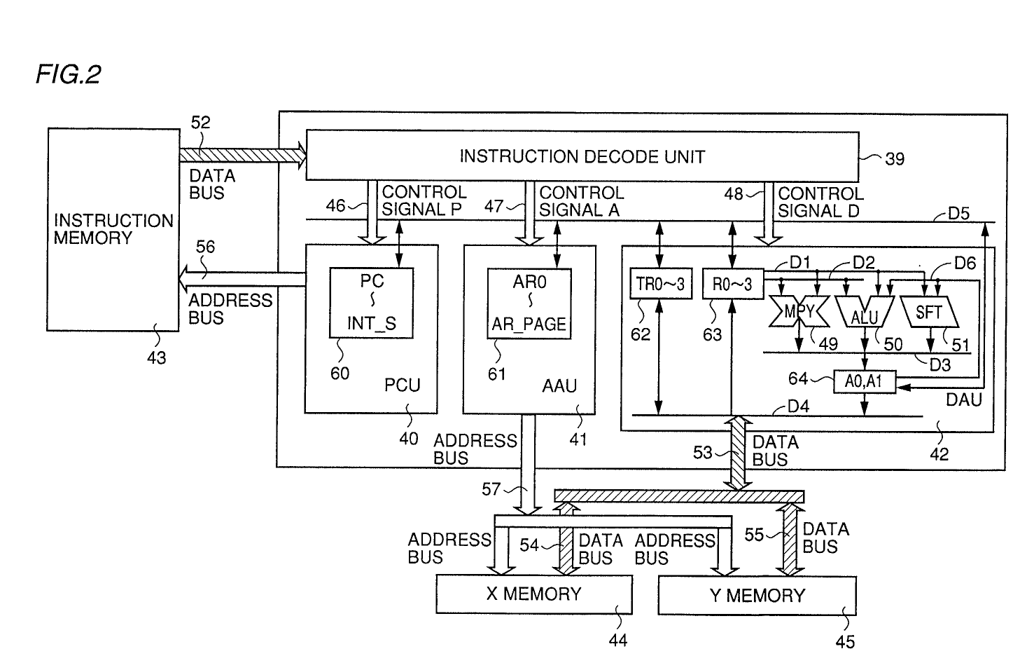

FIG. 2 is a block diagram schematically showing the structure of the microprocessor according to this embodiment. This microprocessor includes an instruction decode unit 39 decoding an instruction fetched from an instruction memory 43, a PCU (program control unit) 40 controlling fetch of instructions stored in the instruction memory 43, an AAU (address arithmetic unit) 41 operating an address for accessing an X memory 44 or a Y memory 45 and a DAU (data arithmetic unit) 42 operating data. The instruction memory 43 stores binary codes of the instructions. The X memory 44 and the Y memory 45 store data such as values to be operated, results and the like.

The instruction decode unit 39 decodes the instruction code fetched from the instruction memory 43 and outputs control signals P46, A47 and D48 in accordance with the instruction code to the PCU 40, the AAU 41 and the DAU 42 respectively. The PCU 40 outputs an address storing an instruction to be subsequently fetched to the instruction memory 43 through an address bus 56 in accordance with the control signal P46 output from the instruction decode unit 39. The AAU 41 generates an address storing data to be read when necessary in accordance with the control signal A47 output from the instruction decode unit 39 and outputs the address to the X memory 44 and the Y memory 45 through an address bus 57.

The DAU 42 includes a multiplier 49 performing a multiplication of 17 bits by 17 bits, an ALU (arithmetic and logic unit) 50 performing operations on two 40-bit data and a shifter 51 performing shift operations on the 40-bit input data right or left by 16 bits. The DAU 42 performs multiplications, additions/subtractions or shift operations on the values held in the aforementioned registers and a value read from the X memory 44 or the Y memory 45 through a data bus 53 in accordance with the control signal D48 output from the instruction decode 39.

The registers shown in FIGS. 1A and 1B are implemented in any of the PCU 40, the AAU 41 and the DAU 42 shown in FIG. 2. The PCU 40 includes a register group 60 of 13 registers PC, PSW, BPC, BPSW, DPC, DPSW, PCLINK, LP_CT, REP_CT, LP_S, LP_E, PC_BRK and INT_S.

The AAU part 41 includes a register group 61 of 13 registers AR0 to AR3, AMD0 to AMD3, AR_SEL, MOD_S, MOD_E, SP and AR_PAGE. The DAU 42 includes a register group 62 of the four registers TR0 to TR3, a register group 63 of the four registers R0 to R3 and a register group 64 of the two registers A0 and A1.

The DAU 42 includes a data bus D1 for receiving data from each register of the register group 63 and transferring the data to one input of the multiplier 49, one input of the ALU 50 or one input of the shifter 51, a data bus D2 for receiving data from each register of the register group 63 and transferring the data to another input of the multiplier 49, another input of the ALU 50 or another input of the shifter 51, and a data bus D3 for receiving data output from the multiplier 49, the ALU 50 or the shifter 51 and transferring the data to each register of the register group 64. The DAU 42 further includes a data bus D6, and performs data transfer from each register of the register group 64 to either the ALU 50 or the shifter 51.

The DAU 42 further includes a data bus D4, for transferring data input in each register of the register group 63 and data output from each register of the register group 64 and bi-directionally transferring data input in/output from each register of the register group 62 through the data bus D4. The DAU 42 further bi-directionally transfers data with the X memory 44 or the Y memory 45 through the data buses D4 and 53.

The microprocessor further includes a data bus D5 for performing bi-directional data transfer between the register groups 60 to 64. When executing an operation instruction for an arithmetic operation, a logical operation or a shift operation, the selected one or more registers in the register group 63 or 64 supply data to the data bus D1 and (or) the data bus D2 or D6, and a prescribed register of the register group 64 stores the result through the data bus D3.

When executing an instruction for data transfer between registers, data is transferred between the registers through the data bus D5. In particular when transferring data from the register A0 or A1 of the register group 64 to any register in the register group 63, the bus D4 is used.

In the case of a load instruction, data is transferred from the X memory 44 or the Y memory 45 to the register group 62 or 63 through the data bus D4. In the case of a store instruction, data is transferred from the register group 62 or 64 to the X memory 44 through the data buses D4 and 53.

The procedure of the aforementioned microprocessor according to the embodiment executing a program stored in the instruction memory 43 is now described. First, the PCU 40 outputs an address storing an instruction code to be fetched to the instruction memory 43 through the address bus 56. The instruction decode unit 39 reads the instruction code output from the instruction memory 43 through the data bus 52 and decodes the instruction code. The instruction decode unit 39 outputs the control signals P46, A47 and D48 in accordance with the result of decoding the instruction code.

The PCU 40 generates an address storing an instruction to be subsequently fetched in accordance with the control signal P46 and outputs this address to the instruction memory 43 through the address bus 56. When the control signal A47 indicates access to one or both of the X memory 44 and the Y memory 45, the AAU 41 generates an address for reading or writing and outputs the address to the X memory 44 and the Y memory 45 through the address bus 57.

The DAU 42 performs operation processing on the basis of the control signal D48. When the control signal D48 means, for example, reading data from the X memory 44 or the Y memory 45 and operating the data the DAU 42 reads data output from the X memory 44 or the Y memory 45 and operates the data. When the control signal D48 means operating the contents of any register and writing the result in the X memory 44, the DAU 42 outputs the result to the X memory 44 through the data buses 53 and 54.

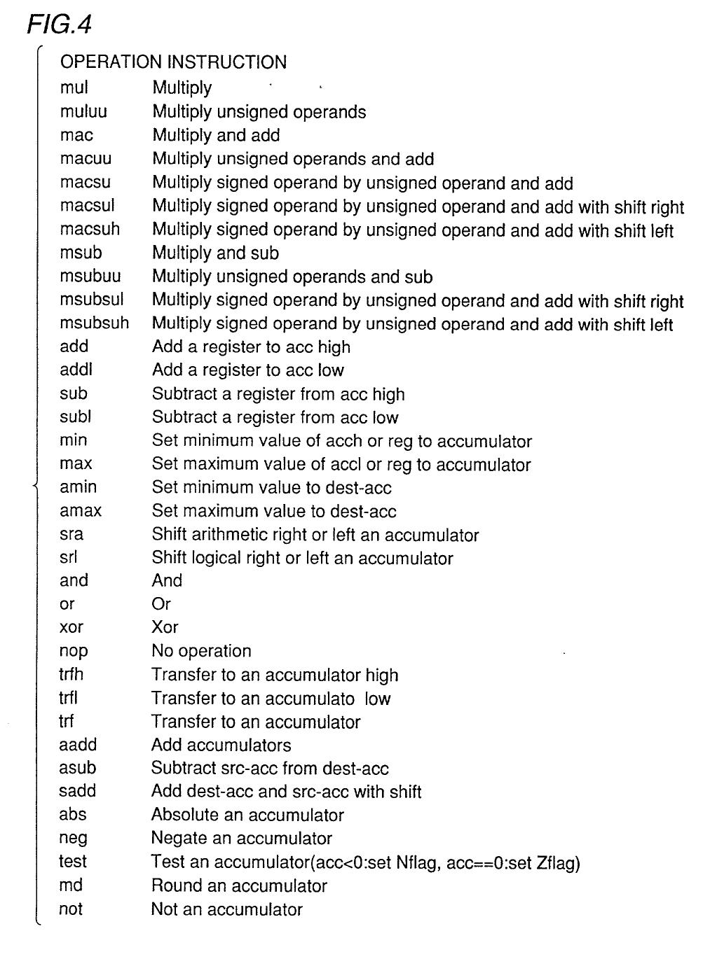

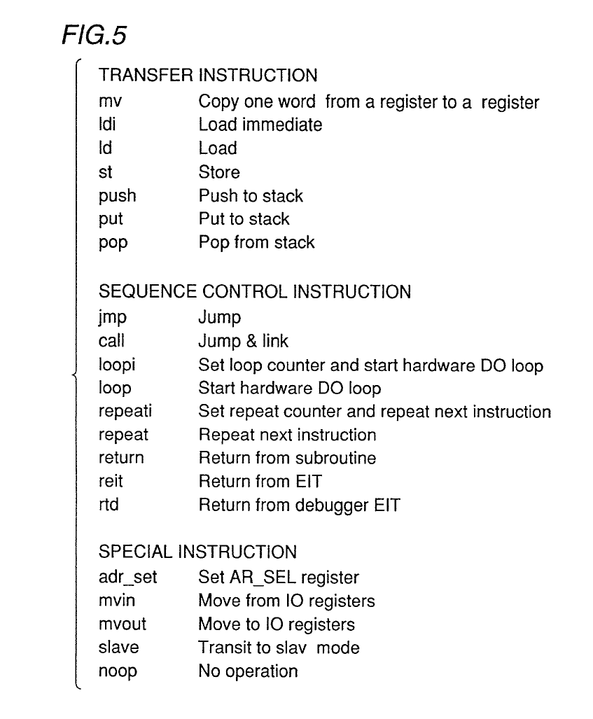

FIG. 4 illustrates exemplary operation instructions processed by the microprocessor according to this embodiment. FIG. 5 illustrates exemplary transfer instructions, sequence control instructions and special instructions processed by the microprocessor according to this embodiment. The details of these instructions, described on the right side of the instructions respectively, are not described.

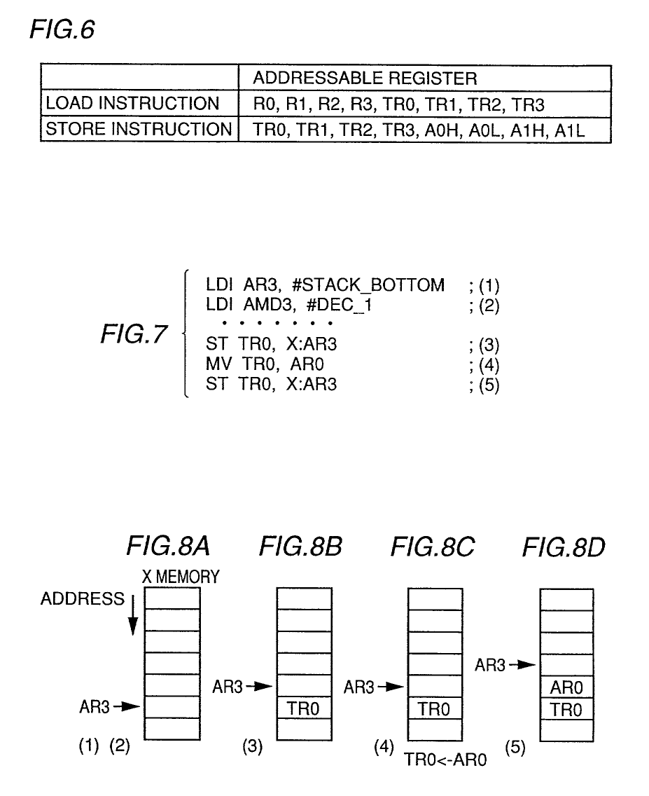

In the instructions shown in FIGS. 4 and 5, LOAD and STORE instructions are for transferring data between the memory and the registers by addressing with the address registers AR0 to AR3. Thus, the address registers AR0 to AR3 can be specified with the instruction to increase freedom in specifying memory to access. However, some of the registers implemented in the DAU 42 can only be specified. In order to push the contents of the registers implemented in the blocks other than the DAU 42 with these instructions, therefore, data must temporarily be transferred to the registers implemented in the DAU 42 with an mv instruction for transfer between the registers for thereafter transferring the data between the registers and the memory. FIG. 6 shows a list of the registers addressable with the LOAD and STORE instructions.

FIG. 7 illustrates an exemplary program for pushing data stored in the registers (TR0 and AR0) with the STORE instruction. Referring to FIG. 7, the address register AR3 and the addressing mode register AMD3 corresponding thereto are initialized at (1) and (2). In other words, #STACK_BOTTOM is assigned to the address register AR3, and #DEC_1 is assigned to the addressing mode register AMD3. #STACK_BOTTOM stands for a constant expressing the highest address of a register push area, and #DEC_1 stands for a constant indicating that the value of the address register AR3 is decremented by 1 every time the register is read.

At (3) in FIG. 7, the value of the work register TR0 is stored in the address of the X memory 44 indicated by the address register AR3. When this instruction is executed, the DAU 42 outputs the value of the work register TR0 implemented therein to the X memory 44 through the data buses 53 and 54. The AAU 41 outputs the value of the address register AR3 implemented therein to the X memory 44 through the address bus 57. Then, the AAU 41 decrements the value of the address register AR3.

At (4) in FIG. 7, the value of the address register AR0 is transferred to the work register TR0. When this instruction is executed, the AAU 41 transfers the value of the address register AR0 implemented therein to the work register TR0 implemented in the DAU 42. At (5) in FIG. 7, the value of the work register TR0 is stored in the address of the X memory 44 indicated by the address register AR3, similarly to (3).

FIGS. 8A to 8D illustrate operations of the stack upon execution of the program shown in FIG. 7. When the instruction codes shown at (1) and (2) in FIG. 7 are executed, the address stored in the address register AR3 indicates a position shown in FIG. 8A. When the instruction code shown at (3) in FIG. 7 is executed, the value of the work register TR0 is stored in the address indicated by the address register AR3, and the value of the address register AR3 is decremented.

When the instruction code shown at (4) in FIG. 7 is executed, the value of the address register AR0 is transferred to the work register TR0 (see FIG. 8C). When the instruction code shown at (5) in FIG. 7 is executed, the value of the work register TR0 (AR0) is stored in the address indicated by the address register AR3, and the value of the address register AR3 is decremented as shown in FIG. 8D. Operations for pop to the register with the LOAD instruction are reverse to the operations shown in FIGS. 7 and 8A to 8D, and hence redundant description is not repeated.

In order to push the contents of any control register on the stack in the transfer system shown in FIGS. 7 and 8A to 8D, the contents of the control register must be transferred through any work register. In order to transfer the contents of N control registers, therefore, instruction codes for (2×N) steps are required.

In the microprocessor according to this embodiment, POP, PUSH and PUT instructions described below are implemented in addition to the register set shown in FIG. 1. FIGS. 9A to 9C are diagrams for illustrating mnemonics of the POP, PUSH and PUT instructions and operations thereof. The PUSH and POP instructions can specify arbitrary registers. The PUT instruction cannot specify any register.

(1) When the POP instruction specifies no register, data stored in the address of the X memory 44 indicated by the stack pointer is transferred to the work register TR0 implemented in the DAU 42, and the value of the stack pointer is incremented, as shown in FIG. 9A. (2) When the POP instruction specifies a register, the value of the work register TR0 is transferred to the register specified by the POP instruction, data stored in the address of the X memory 44 specified by the stack pointer is transferred to the work register TR0 implemented in the DAU 42 through the data buses 53 and 54, and thereafter the value of the stack pointer is incremented.

(1) When the PUSH instruction specifies no register, the value of the stack pointer is decremented, as shown in FIG. 9B. (2) When the PUSH instruction specifies a register, data stored in the work register TR0 implemented in the DAU 42 is stored in the address of the X memory 44 specified by the stack pointer, the value of the register specified by the PUSH instruction is transferred to the work register TR0, and thereafter the value of the stack pointer is decremented.

When the PUT instruction is executed, data stored in the work register TR0 implemented in the DAU 42 is transferred to the address of the X memory 44 specified by the stack pointer as shown in FIG. 9C. The value of the stack pointer is not updated when the PUT instruction is executed.

While the value of the stack pointer is incremented in the POP instruction and decremented in the PUSH instruction, the value of the stack pointer may alternatively be decremented in the POP instruction and incremented in the PUSH instruction.

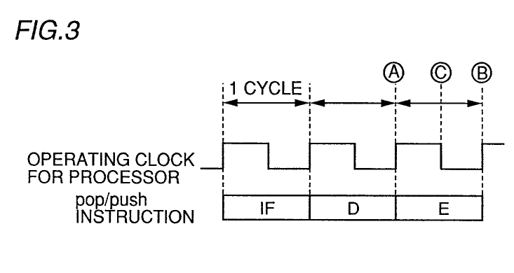

The operations of the aforementioned POP, PUSH and PUT instructions are now described in detail. FIG. 3 is a diagram for illustrating pipeline processing of the microprocessor according to this embodiment. These instructions are processed cycle by cycle with an operating clock through a three-stage pipeline of instruction fetch IF, instruction decode D and instruction execution E.

A POP instruction with an operand is triggered on the rising edge of the operating clock at a time (A) so that data stored in the register TR0 of the register group 62 is output to the data bus D5 while data stored in an area of the X memory indicated by the stack pointer SP is output to the data bus D4 through the data bus 53. On the rising edge of the operating clock at a time (B), the data output to the data bus D5 is written in the register in the register group 60, 61, 63 or 64, specified with POP instruction. At the same time, the data output to the data bus D4 is written in the register TR0, and the value of the stack pointer SP is incremented. This data transfer may alternatively be made on the falling edge of the operating clock at a time (C).

A POP instruction with no operands is triggered on the rising edge of the operating clock at the time (A) so that data stored in an area of the X memory 44 indicated by the stack pointer SP is output to the data bus D4 through the data bus 53. Triggered on the edge of the operating clock at the time (B), the value of the data bus D4 is written in the register TR0 while the value of the stack pointer SP is incremented at the same time.

A PUSH instruction with operands is triggered on the rising edge of the operating clock at the time (A) so that data stored in the register TR0 is output to the data bus 53 through the data bus D4 and written in an area of the X memory 44 indicated by the stack pointer SP. At the same time, data stored in a register, belonging to the register group 60, 61, 63 or 64, specified by the PUSH instruction is output to the data bus D5. On the rising edge of the operating clock at the time (B), the data output to the data bus D5 is written in the register TR0, and the value of the stack pointer SP is decremented at the same time.

A PUSH instruction with no operands is triggered on the rising edge of the operating clock at the time (B), and the value of the stack pointer SP is incremented.

A PUT instruction is triggered on the rising edge of the operating clock at the time (A), and data stored in the register TR0 is written in an area of the X memory 44 indicated by the stack pointer SP through the data buses 53 and D4.

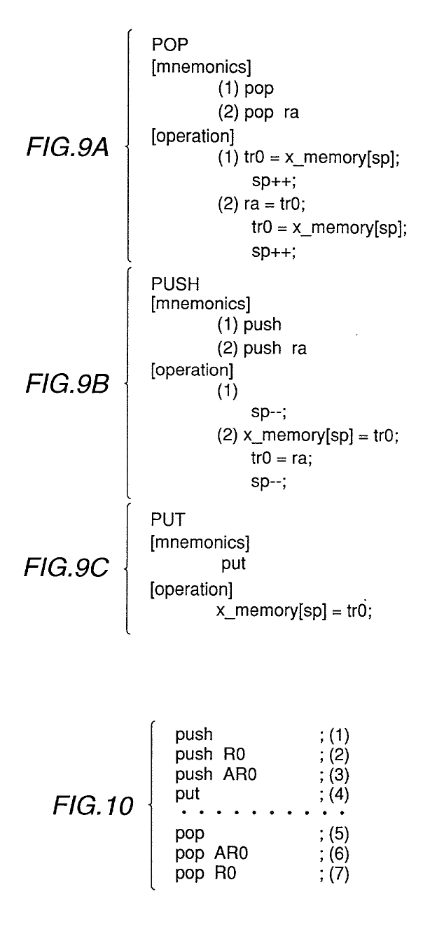

FIG. 10 illustrates an exemplary program using the aforementioned POP, PUSH and PUT instructions. This program is employed for pushing data stored in the operation source register R0 and the address register AR0 and thereafter popping the same. Referring to FIG. 10, “push” shown at (1) indicates that the value of the stack pointer is decremented for pointing to a free area in the stack. Further, “push R0” shown at (2) in FIG. 10 indicates that the value of the work register TR0 is stored in the address of the X memory 44 indicated by the stack pointer, the value of the operation source register R0 is transferred to the work register TR0 and thereafter the value of the stack pointer is decremented.

“Push AR0” shown at (3) in FIG. 10 indicates that the value of the work register TR0 is stored in the address of the X memory 44 indicated by the stack pointer, the value of the address register AR0 is transferred to the work register TR0 and thereafter the value of the stack pointer is decremented. “Put” shown at (4) in FIG. 10 indicates that the value of the work register TR0 is stored in the address of the X memory 44 indicated by the stack pointer.

“Pop” shown at (5) in FIG. 10 indicates that data stored in the address of the X memory 44 indicated by the stack pointer is transferred to the work register TR0 and thereafter the value of the stack pointer is decremented. “Pop AR0” shown at (6) in FIG. 10 indicates that the value of the work register TR0 is transferred to the address register AR0, data stored in the address of the X memory 44 indicated by the stack pointer is transferred to the work register TR0 and thereafter the value of the stack pointer is incremented. “Pop R0” at (7) in FIG. 10 indicates that the value of the work register TR0 is transferred to the operation source register R0, data stored in the address of the X memory 44 indicated by the stack pointer is transferred to the work register TR0 and thereafter the value of the stack pointer is incremented.

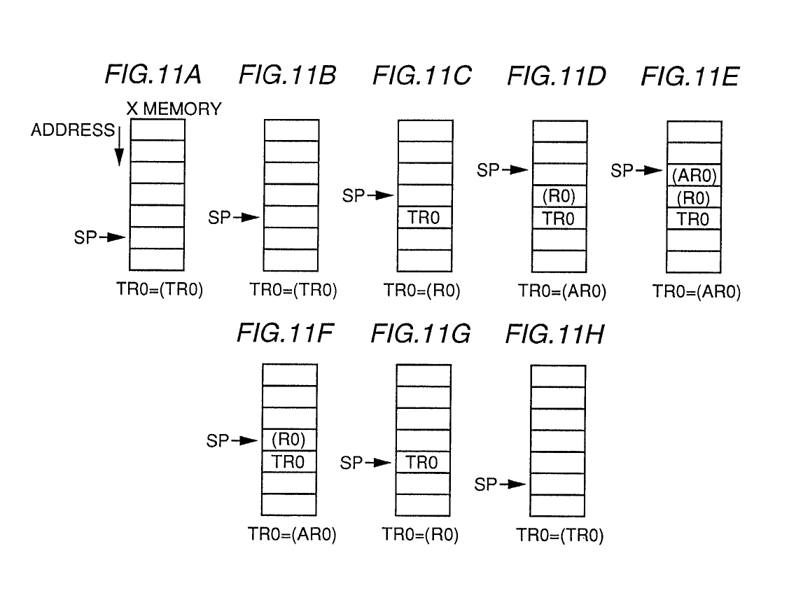

FIGS. 11A to 11H are diagrams for illustrating operations of the stack upon execution of the program shown in FIG. 10. Before executing the program shown in FIG. 10, the stack pointer points to a position shown in FIG. 11A. When executing the instruction shown at (1) in FIG. 10, the value of the stack pointer is decremented so that the stack pointer points to a free area, as shown in FIG. 11B. When executing the instruction shown at (2) in FIG. 10, the value of the work register TR0 is stored in the address of the X memory 44 indicated by the stack pointer. The value of the operation source register R0 is transferred to the work register TR0 as shown in FIG. 11C, and thereafter the value of the stack pointer is decremented.

When executing the instruction shown at (3) in FIG. 10, the value (R0) of the work register TR0 is stored in the address of the X memory 44 indicated by the stack pointer. The value of the address register AR0 is transferred to the work register TR0 as shown in FIG. 11D, and thereafter the value of the stack pointer is decremented. When executing the instruction shown at (4) in FIG. 10, the value (AR0) of the work register TR0 is stored in the address of the X memory 44 indicated by the stack pointer. The value of the stack pointer is not updated at this time (see FIG. 11E).

When executing the instruction shown at (5) in FIG. 10, the data (AR0) stored in the address of the X memory 44 indicated by the stack pointer is transferred to the work register TR0. Then the value of the stack pointer is incremented, as shown in FIG. 11F. When executing the instruction shown at (6) in FIG. 10, the value of the work register TR0 is transferred to the address register AR0, and the data (R0) stored in the address of the X memory 44 indicated by the stack pointer is transferred to the work register TR0. The value of the stack pointer is incremented as shown in FIG. 11G.

When finally executing the instruction shown at (7) in FIG. 10, the value of the work register TR0 is transferred to the operation source register R0, and the data stored in the address of the X memory 44 indicated by the stack pointer is transferred to the work register TR0. Then, the value of the stack pointer is incremented as shown in FIG. 11H. Thus, data stored in N control registers can be pushed through (N+2) steps and popped through (N+1) steps by performing stack operations with the PUSH, POP and PUT instructions.

As hereinabove described, the microprocessor according to this embodiment transfers data from the control register to the work register and from the work register to the X memory 44 with a single push instruction and transfers data from the X memory 44 to the work register and from the work register to the control register with a single pop instruction, thereby pushing and popping a plurality of control registers through a small number of steps. Further, the microprocessor performs the aforementioned operations with the push and pop instructions, whereby data buses may not be connected to the AAU 41 but the circuit structure of a microprocessor of the RISC system can be employed for simplifying the internal circuit structure of the microprocessor.

### Second Embodiment

A second embodiment of the present invention relates to an assembler converting a program to a machine language executable by the microprocessor described with reference to the first embodiment. This assembler is implemented on a computer, such as a personal computer or a workstation executing an assembly program.

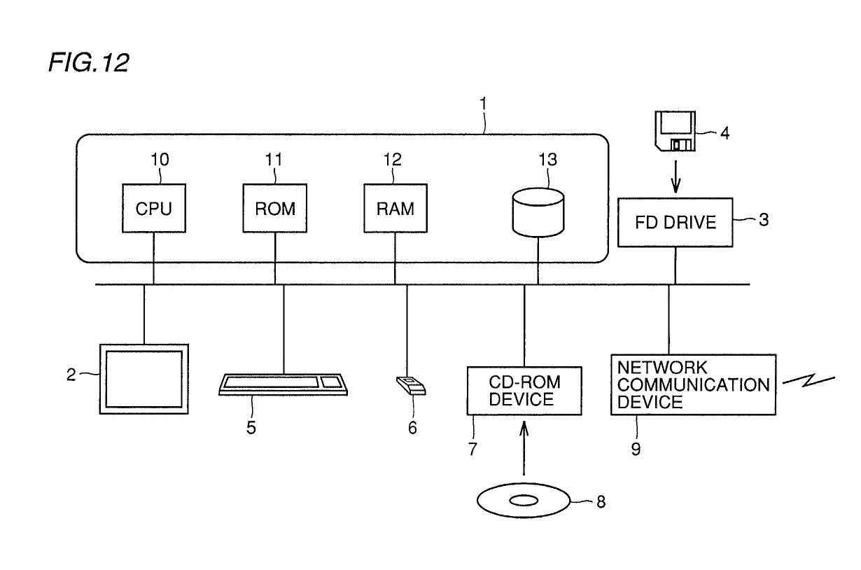

FIG. 12 is a block diagram showing an exemplary structure of a computer implementing the assembler. This computer includes a computer body 1, a graphic display 2, an FD drive 3 on which an FD (floppy disk) 4 is mounted, a keyboard 5, a mouse 6, a CD-ROM device 7 on which a CD-ROM (compact disc-read only memory) 8 is mounted and a network communication device 9.

A storage medium such as the FD 4 or the CD-ROM 8 supplies the assembly program. The computer body 1 executes the assembly program for converting a program produced by a programmer to a machine language executable by the microprocessor described with reference to the first embodiment. Another computer may alternatively supply the assembly program to the computer body 1 through a communication line.

The computer body 1 includes a CPU 10, a ROM (read only memory) 11, a RAM (random access memory) 12 and a hard disk 13. The CPU 10 performs processing while inputting/outputting data from/to the graphic display 2, the FD drive 3, the keyboard 5, the mouse 6, the CD-ROM device 7, the network communication device 9, the ROM 11, the RAM 12 or the hard disk 13. The CPU 10 temporarily stores the assembly program recorded in the FD 4 or the CD-ROM 8 in the hard disk 13 through the FD drive 3 or the CD-ROM device 7. The CPU 10 performs processing by properly loading the assembly program on the RAM 12 from the hard disk 13 and executing the same.

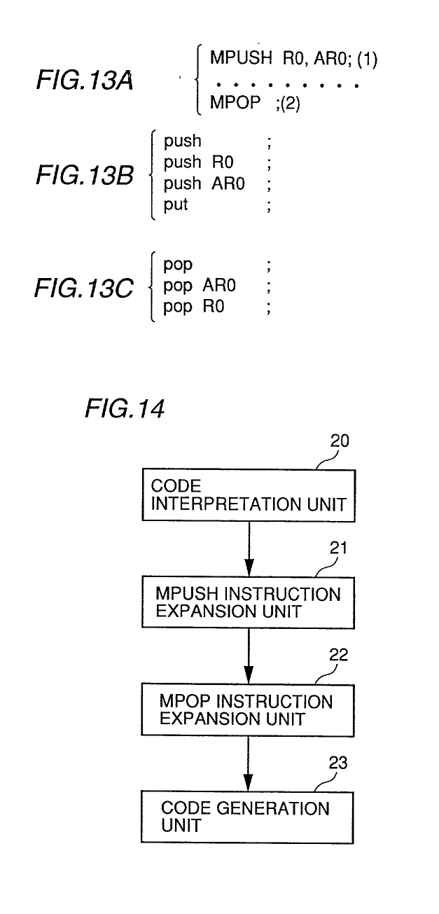

FIGS. 13A to 13C are diagrams for illustrating macro instructions processed by the assembler according to this embodiment. Referring to FIG. 13A, a macro instruction “MPUSH R0, AR0;” shown at (1) indicates push of the operation source register R0 and the address register AR0. It is assumed that registers to be pushed are specified subsequently to “MPUSH” and the number of the registers is not particularly restricted.

A macro instruction “MPOP” shown at (2) in FIG. 13A, corresponding to the precedently described macro instruction “MPUSH”, pops all contents of the registers pushed with the macro instruction “MPUSH”. The notations for the macro instructions are not restricted to these but equivalent instruction codes after expansion of macro instructions must be regarded as identical.

FIG. 13B shows instruction codes expanded from the macro instruction “MPUSH” shown in FIG. 13A. FIG. 13C shows instruction codes upon expansion of the macro instruction “MPOP” shown in FIG. 13A. The program contents shown in FIGS. 13B and 13C are identical to those shown in FIG. 10, and hence redundant description is not repeated.

FIG. 14 is a block diagram schematically showing the functional structure of the assembler according to this embodiment. This assembler includes a code interpretation unit 20 reading codes row by row from a source file and interpreting the read codes, an MPUSH instruction expansion unit 21 expanding the MPUSH instruction to instruction codes, an MPOP instruction expansion unit 22 expanding the MPOP instruction to instruction codes, and a code generation unit 23 generating codes of instructions other than the MPUSH and MPOP instructions.

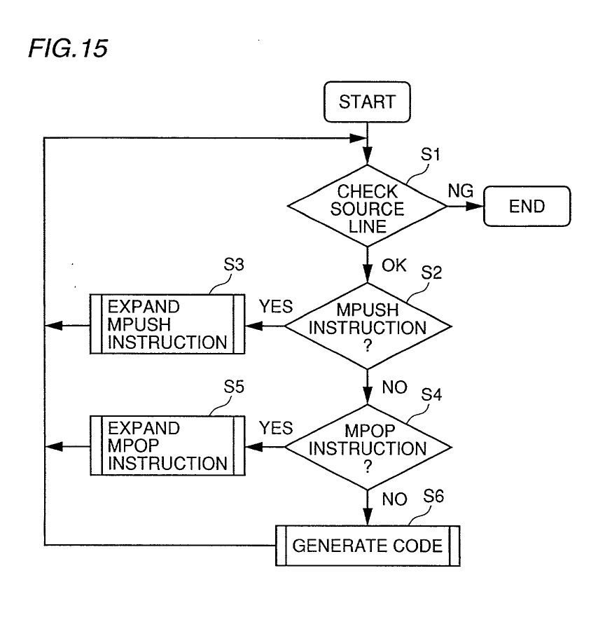

FIG. 15 shows the procedure of the assembler according to this embodiment. First, the code interpretation unit 20 reads a line from the source file and determines whether or not the code of the source line has an error and whether or not the source line is the last line (S1). If the code of the source line has an error or the source line is the last line (NG at S1), the code interpretation unit 20 ends the processing.

If the source line is not the last line and the code has no error (OK at S1), the code interpretation unit 20 determines whether or not the code is an MPUSH instruction (S2). If the code is an MPUSH instruction (YES at S2), the MPUSH instruction expansion unit 21 expands the MPUSH instruction (S3) and stores the result in the RAM 12. Thereafter the process returns to the step S1 for repeating the subsequent processing.

If the code is not an MPUSH instruction (NO at S2), the code interpretation unit 20 determines whether or not the code is an MPOP instruction (S4). If the code is an MPOP instruction (YES at S4), the MPOP instruction expansion unit 22 expands the MPOP instruction (S5), and the process returns to the step S1 for repeating the subsequent processing. If the code is not an MPOP instruction (NO at S4), the code generation unit 23 generates a general code (S6) and stores the code in the RAM 12. Thereafter the process returns to the step S1 for repeating the subsequent processing.

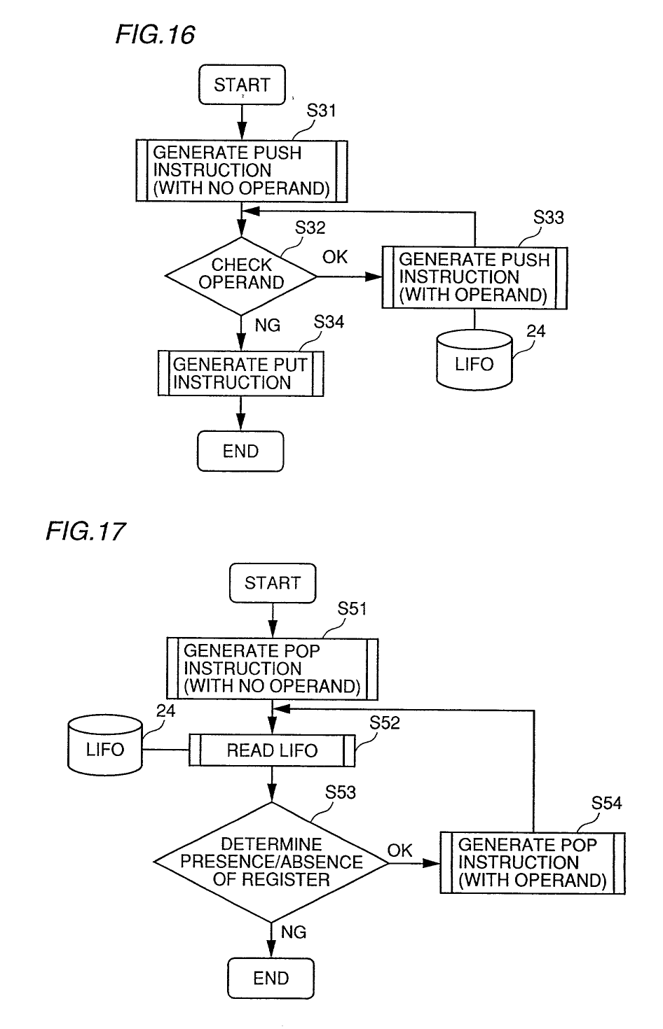

FIG. 16 is a flow chart for illustrating the processing (expansion of the MPUSH instruction) at the step S3 in FIG. 15 in further detail. First, the MPUSH instruction expansion unit 21 generates a PUSH instruction with no operands (specifying no register) and stores the codes thereof in the RAM 12. Then, the MPUSH instruction expansion unit 21 checks the operands of the MPUSH instruction (S32). The MPUSH instruction expansion unit 21 successively checks the operands specified with the MPUSH instruction, and if an unprocessed operand is present (OK at S32), the MPUSH instruction expansion unit 21 generates a PUSH instruction including this operand and stores its codes in the RAM 21 while storing the operand in an LIFO memory 24 (S33). Then, the process returns to the step S32 for repeating the subsequent processing. If no unprocessed operand is present (NG at S32), a PUT instruction is generated and its codes are stored in the RAM 12 (S34).

Thus, the MPUSH instruction is expanded and its codes are stored in the RAM 12. In the case of the MPUSH instruction shown at (1) in FIG. 13A, for example, the operand R0 is first extracted and a code “push R0” is generated at the step S33. Then, the operand AR0 is extracted and a code “push AR0” is generated. The LIFO memory 24 shown in FIG. 16 is formed in the RAM 12 or the hard disk 13 shown in FIG. 12.

FIG. 17 is a flow chart for illustrating the processing (expansion of the MPOP instruction) at the step S5 of FIG. 15 in further detail. First, the MPOP instruction expansion unit 22 generates a POP instruction having no operands (specifying no registers) and stores its codes in the RAM 12 (S51). Then, the MPOP instruction expansion unit 22 reads the operands stored in the LIFO memory 24 when expanding the MPUSH instruction (S52) and determines presence/absence of an unprocessed operand (register) (S53).

If an unprocessed operand is present (OK at S53), the MPOP instruction expansion unit 22 generates a POP instruction including the operand and stores its codes in the RAM 12 (S54). Then the process returns to the step S54 for repeating the subsequent processing. If no unprocessed operand is present (NG at S53), the MPOP instruction expansion unit 22 ends the processing.

Thus, the MPOP instruction is expanded and its codes are stored in the RAM 12. In the case of the MPOP instruction shown at (2)in FIG. 13A, for example, the LIFO memory 24 stores “R0” and “AR0” and hence the operand AR0 is first extracted at a step S54 and a code “pop AR0” is generated. Then, the operand R0 is extracted and a code “pop R0” is generated.

As hereinabove described, the assembler according to this embodiment expands a macro instruction to codes executable by the microprocessor described with reference to the first embodiment, whereby codes for performing a series of stack operations can be generated by simply describing a macro instruction including registers to be pushed and popped. Therefore, the programmer may not confirm consistency of the stack operations etc., and productivity in software development can be improved.

### Third Embodiment

The aforementioned assembler according to the second embodiment uses the work register TR0 as a medium of register transfer. As understood from the description of FIGS. 11A to 11H, the assembler automatically stores the value of the work register TR0 in the stack regardless of presence/absence of push of the work register TR0. An assembler according to a third embodiment of the present invention utilizes this characteristic.

The functional structure of the assembler according to the third embodiment is different from that of the assembler according to the second embodiment shown in FIG. 14 only in the function of an MPUSH instruction expansion unit. Further, the procedure of the assembler according to the third embodiment is identical to that of the assembler according to the second embodiment shown in FIG. 15. Therefore, redundant description is not repeated. Numeral 21′ denotes the MPUSH instruction expansion unit according to the third embodiment.

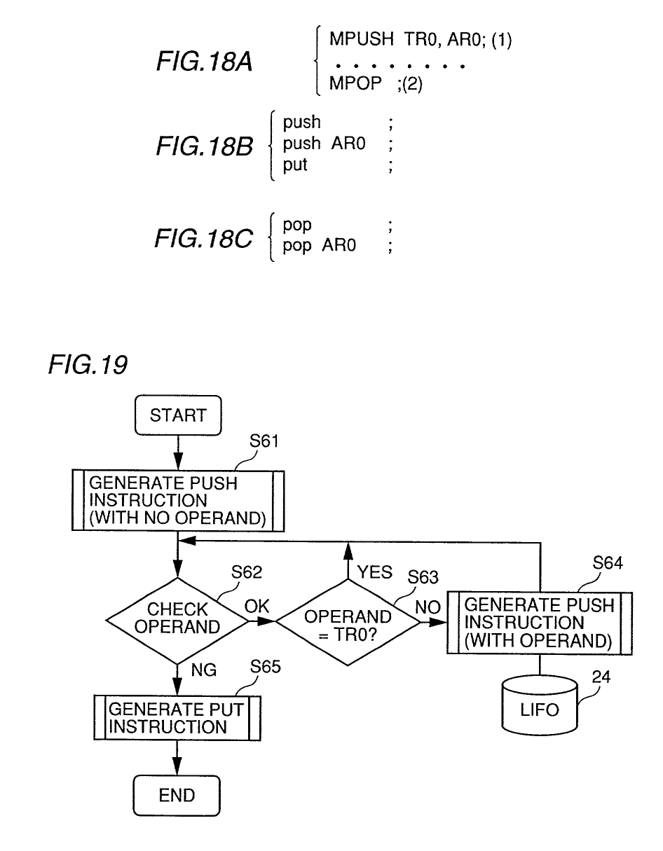

FIGS. 18A to 18C are diagrams for illustrating macro instructions processed by the assembler according to the third embodiment. Referring to FIG. 18A, a macro instruction “MPUSH TR0,AR0;” at (1) indicates that a work register TR0 and an address register AR0 are pushed. It is assumed that registers to be pushed are specified subsequently to “MPUSH”, and the number of the registers is not particularly restricted.

A macro instruction “MPOP” shown at (2) in FIG. 18A, corresponding to the precedently described macro instruction “MPUSH”, pops all contents of the registers pushed by the macro instruction “MPUSH”. The notations for the macro instructions are not restricted to these but equivalent instruction codes after expansion of macro instructions must be regarded as identical.

FIG. 18B shows instruction codes expanded from the macro instruction “MPUSH” shown in FIG. 18A. FIG. 18C shows instruction codes expanded from the macro instruction “MPOP” shown in FIG. 18A. It follows that the work register TR0 is automatically stored in a stack, and hence no push instruction corresponding to the work register TR0 is generated. When a register other than the work register TR0 is popped, the work register TR0 is also popped automatically and hence no pop instruction corresponding to the work register TR0 is generated either.

FIG. 19 is a flow chart for illustrating the processing (expansion of the MPUSH instruction) at the step S3 in FIG. 15. First, the MPUSH instruction expansion unit 21′ generates a PUSH instruction with no operands (specifying no registers) and stores its codes in a RAM 12 (S61). Then, the MPUSH expansion unit 21′ checks the operands of the MPUSH instruction (S62).

The MPUSH instruction expansion unit 21′ successively checks the operands described in the MPUSH instruction, and if an unprocessed operand is present (OK at S62), the MPUSH instruction expansion unit 21′ determines whether or not the operand is the work register TR0 (S63). If the operand is the work register TR0 (YES at S63), the MPUSH instruction expansion unit 21′ returns to the step S62 and repeats the subsequent processing.

If the operand is not the work register TR0 (NO at S63), the MPUSH instruction expansion unit 21′ generates a PUSH instruction including the operand and stores its codes in the RAM 12 while storing the operand in an LIFO memory 24 (S64). Then, the MPUSH instruction expansion unit 21′ returns to the step S62 and repeats the subsequent processing. If no unprocessed operand is present (NG at S62), the MPUSH instruction expansion unit 21′ generates a PUT instruction, stores its codes in the RAM 12 (S65) and ends the processing.

As hereinabove described, the assembler according to this embodiment generates no instruction for pushing/popping a register used as a medium in data transfer between registers and a memory, whereby generation of redundant codes can be prevented in push/pop of registers, so that the number of program steps can be reduced, the processing speed can be improved and the size of the used memory can be reduced.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A microprocessor including:
a program control unit controlling fetch of an instruction code;
an instruction decode unit decoding said fetched instruction code;
an address operation unit operating an address of a memory on the basis of the result of decoding by said instruction decode unit; and
a data operation unit operating data on the basis of the result of decoding by said instruction decode unit, wherein
said data operation unit executes data transfer between registers and data transfer between said registers and said memory in correspondence to single said instruction code having a single operation code fetched by said program control unit.

2. The microprocessor according to claim 1, wherein said data operation unit transfers data stored in a first register to said memory and transfers data stored in a second register to said first register in correspondence to a single push instruction fetched by said program control unit.

3. The microprocessor according to claim 2, wherein said data operation unit decrements the value of a stack pointer after transferring said data stored in said second register to said first register.

4. The microprocessor according to claim 2, wherein said first register is a work register implemented in said data operation unit.

5. The microprocessor according to claim 2, wherein said second register is a control register implemented in one of said address operation unit and said program control unit.

6. The microprocessor according to claim 1, wherein said data operation unit transfers data stored in a first register to a second register and transfers data stored in said memory to said first register in correspondence to a single pop instruction fetched by said program control unit.

7. The microprocessor according to claim 6, wherein said data operation unit increments the value of a stack pointer after transferring said data stored in said memory to said first register.

8. The microprocessor according to claim 6, wherein said first register is a work register implemented in said data operation unit.

9. The microprocessor according to claim 6, wherein said second register is a control register implemented in one of said address operation unit and said program control unit.

10. The microprocessor according to claim 1, wherein said data operation unit transfers data stored in a first register to said memory and keeps the value of a stack pointer unchanged for a single push instruction fetched by said program control unit.

11. An assembler including:
a code reading unit reading a code from a source program;
a storage unit storing information for specifying a plurality of registers;
a first code generation unit storing said information for specifying said plurality of registers included in said code read by said code reading unit in said storage unit and generating a code to push data stored in said plurality of registers when said code is a first macro instruction; and
a second code generation unit referring to said information for specifying said plurality of registers stored in said storage unit and generating a code to pop data stored in said plurality of registers when said code read by said code reading unit is a second macro instruction.

12. The assembler according to claim 11, wherein said first code generation unit generates a code to push data stored in registers other than a register used as a medium for data transfer between said registers and a memory among said plurality of registers included in said code when said code read by said code reading unit is said first macro instruction.

13. A storage medium, readable by a computer, on which an assembly program for making said computer execute an assembly method is recorded, said assembly method comprising the steps of:
reading a code from a source program;
storing information for specifying a plurality of registers included in said code and generating a code to push data stored in said plurality of registers when said code is a first macro instruction; and
referring to said stored information for specifying said plurality of registers and generating a code to pop data stored in said plurality of registers when said read code is a second macro instruction.

14. The recording medium recording an assembly program according to claim 13, wherein said step of storing information for specifying a plurality of registers included in said code and generating said code to push data stored in said plurality of registers includes the step of generating a code to push data stored in registers other than a register used as a medium for data transfer between said registers and a memory among said plurality of registers included in said read code when said read code is said first macro instruction.
